(19) United States
(12) Patent Application Publication
(10) Pub. No.: US 2006/0187842 A1
(43) Pub. Date: Aug. 24, 2006

(54) Best path routing

(76) Inventor: Daren French, Irvine, CA (US)

Correspondence Address: XROADS NETWORKS, SUITE 112, 17165 VON KARMAN, IRVING, CA, 92614, US

(21) Appl. No.: 11/062,336

(22) Filed: Feb. 22, 2005

(51) Int. Cl. H04L 12/66

(52) U.S. Cl. 370/238

(57) ABSTRACT

A method used to determine the most optimal network path to a specific remote network and direct traffic over the optimal path to that remote network when two or more diverse network paths are available.

### REFERENCES CITED

Vector Routing White Paper, September 2001.

Vector Routing Provisional Patent Filed June 2001.

### BACKGROUND

In large computer networks, such as the Internet, the entire network is actually made up of many smaller networks. Each of those smaller networks use their own methods to route traffic, some better than others. Due to various adoptions of practices, it is very difficult to provide guarantees in terms of packet loss, latency, etc to every network and every node on this large network. There are simply too many smaller networks using too many different routing technologies to ensure that the data sent from one end of a network connection to the other is handled and/or treated the same.

Many providers over the years have begun to implement standards within their own networks in an attempt to increase reliability and ensure that network traffic is handled the same from one end to the other.

The problem is that in most cases, the businesses that use the Internet have offices, and/or partners which do not use the same network provider and thus data traffic between these offices is not guaranteed.

This generally means that as the data leaves one office bound for a partners office, the data must be exchanged from one service provider to another. Even if the first provider has a particular SLA (Service Level Agreement) with the customer sending the traffic, there is generally no agreement with the second service provider, and thus the data is delivered with minimal, if any, SLAs.

With most web and email traffic this is not a major problem, however when it comes to critical latency sensitive data, such as VPNs, VoIP, and Point of Sale systems, SLAs and quality of the service becomes critical.

### SUMMARY

The present invention seeks to provide a novel method for optimizing network traffic by probing the critical remote networks via two or more diverse network paths, and then selecting the path that provides the overall best route, i.e. the lowest latency, lowest packet loss, and lowest calculated jitter. Using this method BPR effectively ensures that the network traffic stays on the same service provider as long as possible, in some cases from one side of the connection to the other.

There is thus provided in accordance with a preferred embodiment of the present invention a method for BPR (Best Path Routing) network path selection, based on the continued measurement of a remote networks defined node via two or more diverse network paths to a larger external network, enabling the local network to also use the most optimal path for sending its data traffic.

In accord with the path selection by the BPR module a change to the routing table is made on the apparatus such that all traffic bound for the associated remote network is sent through the appropriate network path.

### DESCRIPTION OF DRAWINGS

The present invention can be understood and better appreciated from the following detailed description, taken in conjunction with the following drawing:

FIG. 1—A pictorial illustration of a typical network session constructed and operative in accordance with the preferred embodiment of the present invention.

### DETAILED DESCRIPTION OF PREFERRED EMBODIMENTS

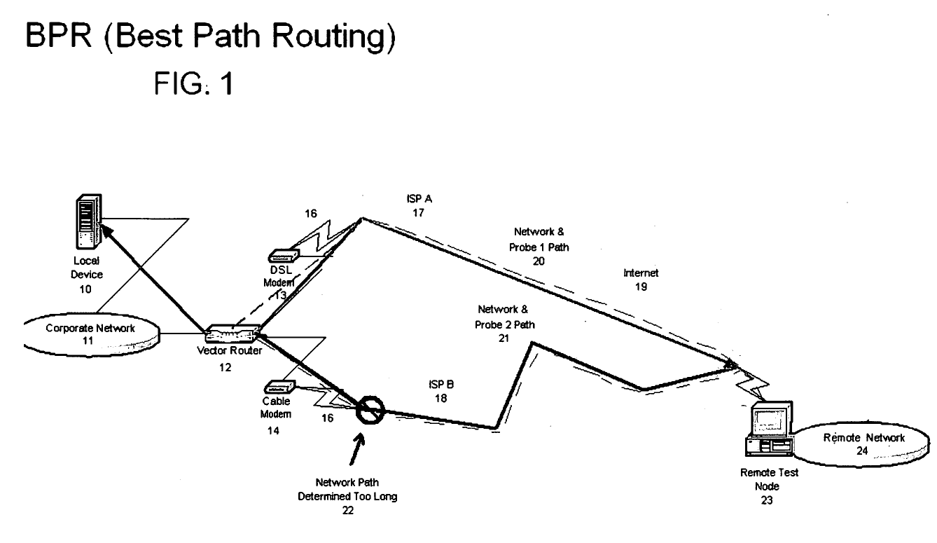

Reference is now made to FIG. 1 that provides the general flow of BPR (Best Path Routing). BPR in this diagram consists of two diverse network paths connected to a computing device which is running the BPR module (software code). The two network paths consist of broadband connection devices 13 and 14, logical broadband data connections 16, their associated networks 17 and 18 and the larger external network (in this case the Internet) 19. To ensure that the local network 11 is using the optimal path, the BPR enabled apparatus 12 sends probe packets via a modified ICMP packet to an administratively defined remote node 23 to gather network measurements to determine which network path is providing the most optimal path of the local networks 11 data.

The modified ICMP packet consists of a standard ICMP packet with specific and predefined bits within the data portion of the packet which the BRP enabled apparatus looks for when determining which path is optimal. Others factors used when determining the best path include latency, packet loss, and calculated jitter. These measurements are then stored within the BRP apparatus for later comparison and manipulation by the BPR algorithm to determine which diverse network path should be used for the associated remote network which has been defined by the administrator.

When the probe packets are sent out via the network paths 20 and 21 to remote node 23, the responses of those packets are used to determine which network path 20 or 21 will be used when sending data packets to the remote network 24. Once this determination has been made, the routing table of the BPR apparatus 12 is updated with route information associated with the optimal network path.

1. A method for determining the best, or preferred, network path from a network apparatus to a remote network by performing various probes through those paths to remote nodes and then comparing the results of those probes to predefined, administratively set, thresholds. If the threshold is not met, the first available network path will be used. If the threshold is met, that network path with no longer be available, and the next most preferred path is used.

2. The method of claim 1, wherein the remote network is defined as an IP based network subnet and the remote node as a device assigned an IP address that falls within the remote networks subnet.

3. The method of claim 1, wherein the path is modified using the BPR module (software code) within the routing table of the network apparatus.

4. The method of claim 1, wherein the network apparatus includes a CPU, read only memory, writeable memory, software which contains executable code which is stored in memory and operates the processor, and three or more network interface connectors.

5. The method of claim 1, wherein the remote nodes are designated by IP address and are predefined by an administrator of the BPR module.

6. The method of claim 1, wherein the probes consists of ICMP packets which include predefined values in the data portion of the packet which assists in determining path acceptability. Other measurements provided by the ICMP response include latency, packet loss, and calculated jitter information. All of the response information is stored in a database for future comparison.

7. The method of claim 1, wherein an algorithm obtains the measurement information from the probes and compares them to the predefined thresholds set by the BPR module administrator for each remote network.

8. The method of claim 1, wherein the algorithm determines whether a particular network path is outside the acceptable threshold as defined by the administrator of the BPR module by using these measurements in combination with the threshold assigned to the remote network.

9. The method of claim 1, wherein graphical representations of the measured responses are provided in a web based GUI interface so that the BPR module administrator may view them.
